(19) United States
(12) Patent Application Publication
(10) Pub. No.: US 2006/0036620 A1
(43) Pub. Date: Feb. 16, 2006

(54) Methods and apparatus for visualizing relationships among triples of resource description framework (RDF) data sets

(75) Inventors: David Bigwood, Sudbury, MA (US); Colin P. Britton, Lexington, MA (US); Alan Greenblatt, Sudbury, MA (US); Howard Greenblatt, Wayland, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: METATOMIX, INC., Waltham, MA (US)

(21) Appl. No.: 11/199,514

(22) Filed: Aug. 8, 2005

Related U.S. Application Data
(63) Continuation of application No. 10/138,725, filed on May 3, 2002, now abandoned.

(51) Int. Cl. G06F 7/00

(52) U.S. Cl. 707/100

(57) ABSTRACT

The invention provides, in one aspect, a method for visualizing relationships among triples of an RDF data set. The method, which can be used with a data set already in RDF form or converted thereto (e.g., from relational, hierarchical or other form), includes the steps of grouping subjects of at least selected ones of the triples based on commonality of at least portions of the identifiers of those subjects. It further includes grouping, for at least a selected subject groups, objects based on commonality of at least portions of identifiers of the predicates of those triples. Icons representing the subject and object groups can be displayed, e.g., on a computer monitor, or otherwise. A related aspect of the invention provides the additional step of displaying icons, e.g., directed arrows, indicating relationships among icons that represent subject group and icons that represent object groups. A display so generated is reminiscent of a directed graph—albeit a novel such graph that represents relationships among groups of subjects and objects, rather than directly between individual subjects and objects.

This application is a continuation of U.S. patent application Ser. No. 10/138,725, filed May 3, 2002, entitled “Methods and Apparatus for Visualizing Relationships Among Triples of Resource Description Framework (RDF) Data Sets,” the teachings of which are incorporated herein by reference.

### BACKGROUND OF THE INVENTION

The invention pertains to digital data processing and, more particularly, to methods and apparatus for data visualization. The invention has application, for example, in enterprise business visibility and insight using real-time reporting tools.

It is not uncommon for a single company to have several database systems—separate systems not interfaced—to track internal and external planning and transaction data. Such systems might have been developed at different times throughout the history of the company and are therefore of differing generations of computer technology. For example, a marketing database system tracking customers may be ten years old, while an enterprise resource planning (ERP) system tracking inventory might be two or three years old. Integration between these systems is difficult at best, consuming specialized programming skill and constant maintenance expenses.

A major impediment to enterprise business visibility is the consolidation of these disparate legacy databases with one another and with newer e-commerce databases. For instance, inventory on-hand data gleaned from a legacy ERP system may be difficult to combine with customer order data gleaned from web servers that support e-commerce (and other web-based) transactions. This is not to mention difficulties, for example, in consolidating resource scheduling data from the ERP system with the forecasting data from the marketing database system.

Even where data from disparate databases can be consolidated, e.g., through data mining, directed queries, brute-force conversion and combination, or otherwise, it may be difficult (if not impossible) to understand and use. For example, the average user may be wholly unable to make sense of a listing of tens, hundreds or even thousands of pages of consolidated corporate ERP, e-commerce, marketing and other data.

An object of this invention is to provide improved methods and apparatus for digital data processing and, more particularly, data visualization.

A related object is to provide such methods and apparatus as facilitate enterprise business visibility and insight.

A further object is to provide such methods and apparatus as can rapidly generate visualizations, e.g., in response to user directives or otherwise.

A still further object is to provide such methods and apparatus as can be used for purposes of data subsetting or querying.

A further object of the invention is to provide such methods and apparatus as can be readily and inexpensively implemented.

### SUMMARY OF THE INVENTION

The foregoing are among the objects attained by the invention which provides, in one aspect, a method for visualizing relationships among triples of a resource description framework (RDF) data set. The method, which can be used with a data set already in RDF form or converted thereto (e.g., from relational, hierarchical or other form), includes the steps of grouping subjects of at least selected ones of the triples based on commonality of at least portions of the identifiers of those subjects. It further includes grouping, for at least a selected subject groups, objects based on commonality of at least portions of identifiers of the predicates of those triples. Icons representing the subject and object groups can be displayed, e.g., on a computer monitor, or otherwise.

A related aspect of the invention provides the additional step of displaying icons, e.g., directed arrows, indicating relationships among icons that represent subject group and icons that represent object groups. A display so generated is reminiscent of a directed graph—albeit a novel such graph that represents relationships among groups of subjects and objects, rather than directly between individual subjects and objects.

Still further aspects of the invention provide methods as described above including displaying with at least one subject or object group-representative icon an indication of a count of subjects or objects, respectively, in the group represented by that icon. A related aspect of the invention provides such methods in which an enumeration of the subjects or objects that make up a group are displayed along with its icon.

Yet still further aspects of the invention provide methods as described above additionally including selectively activating or deactivating displayed icons, e.g., in response to user directives. This can be done, e.g., by emphasizing or de-emphasizing color, brightness or other aspects of the icon display.

Still yet further aspects of the invention provide as described above additionally including activating or deactivating displayed icons in response to user selection of an enumerated subject or object. This can include activating or deactivating icons for groups of triples related to one or more triples having an identifier corresponding to the subject or object selected in the enumeration.

Other aspects of the invention provide methods as described above additionally including generating any of the subset and the query on a basis of a user selection of any of a subject an object in an enumeration.

Still other aspects of the invention provide digital data processing or other apparatus operating according to the methods described above.

These and other aspects of the invention are evident in the drawings and in the description that follows.

### BRIEF DESCRIPTION OF THE DRAWINGS

A more complete understanding of the invention may be attained by reference to the drawings, in which:

FIG. 1 is an excerpt of an RDF data set of the type with whcih the invention can be used;

FIG. 2 depicts a directed graph generated from the data set of FIG. 1; 10 FIGS. 3A-3C depict meta-directed graphs generated from the data set of FIG. 1 using methods and apparatus of the invention;

FIGS. 4A-4C and 5A-5B depict selective activation of icons in meta-directed graphs 15 of the invention;

FIGS. 6A-6B depict display of self-referencing subject groups in meta-directed graphs of the invention;

FIG. 7 is a flow chart of operation of an apparatus according to the invention.

### DETAILED DESCRIPTION OF THE ILLUSTRATED EMBODIMENT

The invention provides methods and apparatus for visualizing relationships among data, e.g., of the type stored in one or more data sets. Though the illustrated embodiment is directed to providing such visualizations for data maintained as resource description framework (“RDF”) triples, it will be appreciated that the invention and the teachings hereof are applicable to data maintained in other representations (e.g., by way of conversion of that data to RDF triples and subsequent application of the techniques herein). The methods and apparatus presented here are appropriate for visualizing relationships not only among data in a single data set (e.g., database), but also among data maintained in multiple data sets. Thus, those methods and apparatus are well suited for use with data consolidated from multiple databases, e.g., in the manner described in the following copending, commonly assigned application, the teachings of which are incorporated herein by reference:
U.S. patent application Ser. No. 09/917,264, filed Jul. 27, 2001, entitled “Methods and Apparatus for Enterprise Application Integration,”
U.S. patent application Ser. No. 10/051,619, filed Oct. 29, 2001, entitled “Methods And Apparatus For Real-time Business Visibility Using Persistent Schema-less Data Storage”
U.S. patent application Ser. No. 60/332,219, filed Nov. 21, 2001, entitled “Methods And Apparatus For Calculation And Reduction Of Time-series Metrics From Event Streams Or Legacy Databases In A System For Real-time Business Visibility” and/or
U.S. patent application Ser. No. 60/332,053, filed Nov. 21, 2001, entitled “Methods And Apparatus For Querying A Relational Database Of RDF Triples In A System For Real-time Business Visibility”

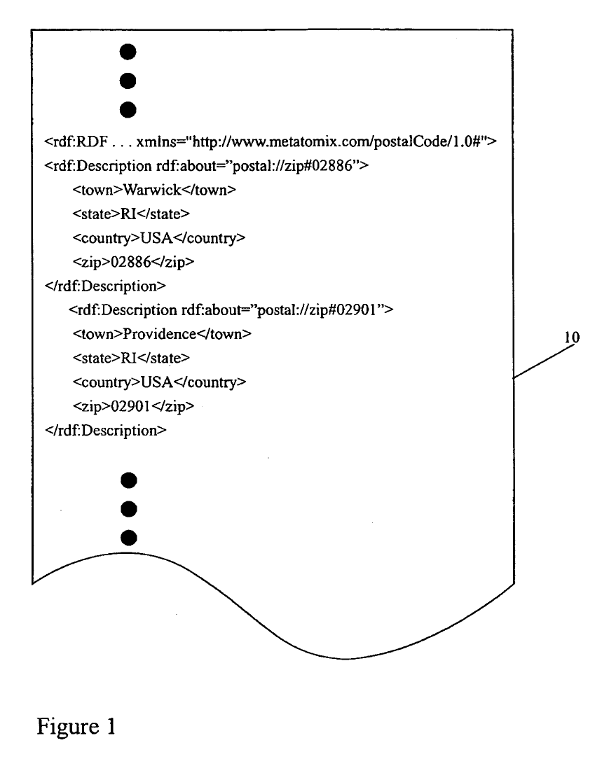

FIG. 1 is a partial listing of a data set of the type with which the invention can be practiced. The illustrated data set contains RDF triples, here, expressed in extensible markup language (XML) syntax. Those skilled in the art will, of course, appreciate that RDF triples can be expressed in other syntaxes and that the teachings hereof are equally applicable to those syntaxes.

By way of background, RDF was developed by the World-Wide Web Consortium as a framework for describing data. According to the RDF specification, Resource Description Framework (RDF) Model and Syntax Specification (Feb. 22, 1999), RDF is a way of expressing the properties of items of data. Those items are referred to as subjects. Their properties are referred to as predicates. And, the values of those properties are referred to as objects. In RDF, an expression of a property of an item is referred to as a triple, a convenience reflecting that the expression contains three parts: subject, predicate and object.

Subjects, also referred to as resources, can be anything that is described by an RDF expression. A subject can be person, place or thing—though, typically, only an identifier of the subject is used in an actual RDF expression, not the person, place or thing itself. Examples of subjects might be “car,” “Joe,” “http://www.metatomix.com.”

A predicate identifies a property of a subject. According to the RDF specification, this may be any “specific aspect, characteristic, attribute, or relation used to describe a resource.” For the three exemplary subjects above, examples of predicates might be “make,” “citizenship,” “owner.”

An object gives a “value” of a property. These might be “Ford,” “United Kingdom,” 20 “Metatomix, Inc.” for the subject and objects given in the prior paragraphs, forming the following RDF triples:

| Subject | Predicate | Object |
|---|---|---|
| “car” | “make” | “Ford” |
| “Joe” | “citizenship” | “United Kingdom” |
| “http://metatomix.com” | “owner” | “Metatomix, Inc.” |

Objects can be literals, i.e., strings that identify or name the corresponding property (predicate). They can also be resources. In the example above, rather than merely the string “Metatomix, Inc.” further triples may be specified—presumably, ones identifying that company in the subject and giving details in predicates and objects.

A given subject may have multiple predicates, each predicate indexing an object. For example, a subject postal zip code might have an index to an object town and an index to an object state, either (or both) index being a predicate URI. One RDF triple implementation is further explained in the context of the illustrated embodiment below.

Referring again to FIG. 1, shown is a listing of RDF triples expressed in XML syntax. These represent, for example, an excerpt of a database 10 containing tens, hundreds or more of such triples. Subjects are indicated within the listing using a “rdf:about” statement. For example, the second line of the listing defines a subject as a resource named “postal://zip#02886.” That subject has predicates and objects which follow the subject declaration.

One predicate, <town>, is associated with a value “Warwick”. Another predicate, <state>, is associated with a value “RI”. The same follows for the predicates <country> and <zip>, which are associated with values “USA” and “02886,” respectively.

Similarly, the listing shows properties for the subject “postal://zip#02901,” namely, <town> “Providence,” <state> “RI,” <country> “US” and <zip> “02901.”

In the illustration, the subjects and predicates are expressed as uniform resource indicators (URIs), e.g., of the type defined in Berners-Lee et al, Uniform Resource Identifiers (URI): Generic Syntax (RFC 2396) (August 1998), and can be said to be expressed in a form <scheme>://<path>#<fragment>. For the subjects given in the example, <scheme> is “postal,” <path> is “zip,” and <fragment> is, for example, “02886” and “02901.”

The predicates, too, are expressed in the form <scheme>://<path>#<fragment>, as is evident to those in ordinary skill in the art. In accord with XML syntax, the predicates in lines two, et seq., of the listing must be interpreted as suffixes to the string provided in the namespace directive “xmlns=http://www.metatomix.com/postalCode/1.0#” in line one of the listing. This results in predicates that are formally expressed as “http://www.metatomix.com/postalCode/1.0#town,” “http://www.metatomix.com/postalCode/1.0#state,” “http://www.metatomix.com/postalCode/1.0#country” and “http://www.metatomix.com/postalCode/1.0#zip.” Hence, the <scheme> for the predicates is “http” and <path> is “www.metatomix.com/postalCode/1.0.” The <fragment> portions are <town>, <state>, <country> and <zip>, respectively.

It is important to note that the listing of FIG. 1 is in some ways simplistic in that each of its objects is a literal value. Commonly, an object may itself be another subject, with its own objects and predicates. In such cases, a resource can be both a subject and an object, e.g., an object to all “upstream” resources and an subject to all “downstream” resources and properties. Such “branching” allows for complex relationships to be modeled within the RDF triple framework.

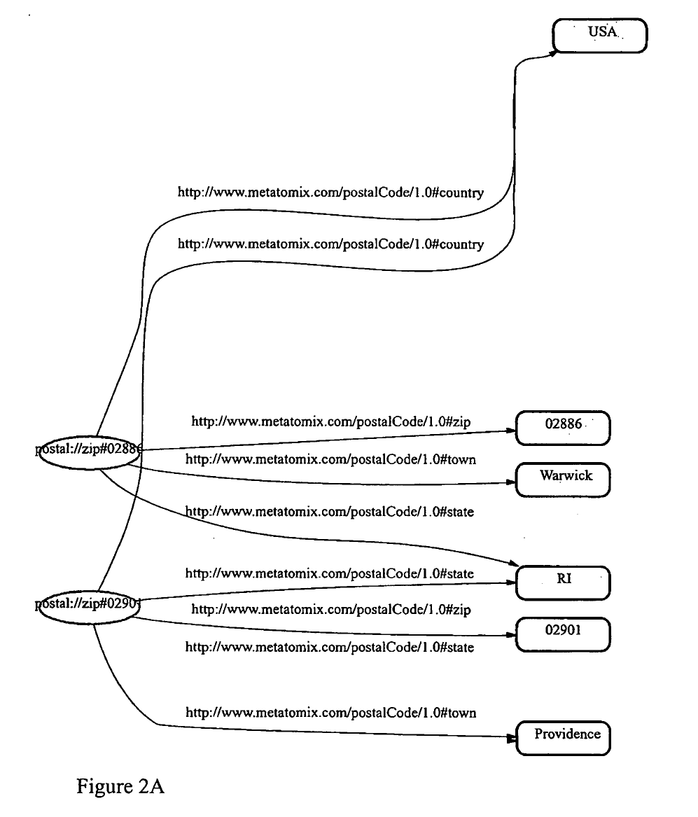

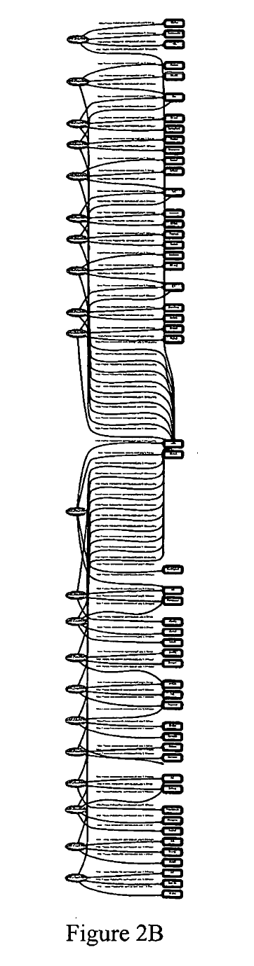

FIG. 2A depicts a directed graph of the type generated in a conventional manner from RDF triples of FIG. 1. Each subject is depicted by a node, here, an oval-shaped node. Those “subject nodes” have directed arcs for each of their respective predicates. Each of those predicates, in turn, terminates at a node representing an associated object, referred to herein as an “object node.”

As one with ordinary skill in the art will appreciate, as an RDF triplet data set grows in size the resultant directed graph becomes large and cumbersome. It becomes difficult to view the graph and ascertain the scope of the relationships. This is illustrated in FIG. 2B, which is a directed graph of the following RDF triple data set, here presented in an alternative, non-XML format:

| Subject | Predicate | Object |
|---|---|---|
| postal://zip#02886 | http://www.metatomix.com/postalCode/1.0#town | Warwick |
| postal://zip#02886 | http://www.metatomix.com/postalCode/1.0#state | RI |
| postal://zip#02886 | http://www.metatomix.com/postalCode/1.0#country | USA |
| postal://zip#02886 | http://www.metatomix.com/postalCode/1.0#zip | 02886 |
| postal://zip#02901 | http://www.metatomix.com/postalCode/1.0#town | Providence |
| postal://zip#02901 | http://www.metatomix.com/postalCode/1.0#state | RI |
| postal://zip#02901 | http://www.metatomix.com/postalCode/1.0#country | USA |
| postal://zip#02901 | http://www.metatomix.com/postalCode/1.0#zip | 02901 |
| postal://zip#02840 | http://www.metatomix.com/postalCode/1.0#town | Newport |
| postal://zip#02840 | http://www.metatomix.com/postalCode/1.0#state | RI |
| postal://zip#02840 | http://www.metatomix.com/postalCode/1.0#country | USA |
| postal://zip#02840 | http://www.metatomix.com/postalCode/1.0#zip | 02840 |
| postal://zip#06340 | http://www.metatomix.com/postalCode/1.0#town | Groton |
| postal://zip#06340 | http://www.metatomix.com/postalCode/1.0#state | CT |
| postal://zip#06340 | http://www.metatomix.com/postalCode/1.0#country | USA |
| postal://zip#06340 | http://www.metatomix.com/postalCode/1.0#zip | 06340 |
| postal://zip#06901 | http://www.metatomix.com/postalCode/1.0#town | Stamford |
| postal://zip#06901 | http://www.metatomix.com/postalCode/1.0#state | CT |
| postal://zip#06901 | http://www.metatomix.com/postalCode/1.0#country | USA |
| postal://zip#06901 | http://www.metatomix.com/postalCode/1.0#zip | 06901 |
| postal://zip#06101 | http://www.metatomix.com/postalCode/1.0#town | Hartford |
| postal://zip#06101 | http://www.metatomix.com/postalCode/1.0#state | CT |
| postal://zip#06101 | http://www.metatomix.com/postalCode/1.0#country | USA |
| postal://zip#06101 | http://www.metatomix.com/postalCode/1.0#zip | 06101 |
| postal://zip#01101 | http://www.metatomix.com/postalCode/1.0#town | Springfield |
| postal://zip#01101 | http://www.metatomix.com/postalCode/1.0#state | MA |
| postal://zip#01101 | http://www.metatomix.com/postalCode/1.0#country | USA |
| postal://zip#01101 | http://www.metatomix.com/postalCode/1.0#zip | 01101 |
| postal://zip#01601 | http://www.metatomix.com/postalCode/1.0#town | Worcester |
| postal://zip#01601 | http://www.metatomix.com/postalCode/1.0#state | MA |
| postal://zip#01601 | http://www.metatomix.com/postalCode/1.0#country | USA |
| postal://zip#01601 | http://www.metatomix.com/postalCode/1.0#zip | 01601 |
| postal://zip#02101 | http://www.metatomix.com/postalCode/1.0#town | Boston |
| postal://zip#02101 | http://www.metatomix.com/postalCode/1.0#state | MA |
| postal://zip#02101 | http://www.metatomix.com/postalCode/1.0#country | USA |
| postal://zip#02101 | http://www.metatomix.com/postalCode/1.0#zip | 02101 |
| postal://zip#03833 | http://www.metatomix.com/postalCode/1.0#town | Exeter |
| postal://zip#03833 | http://www.metatomix.com/postalCode/1.0#state | NH |
| postal://zip#03833 | http://www.metatomix.com/postalCode/1.0#country | USA |
| postal://zip#03833 | http://www.metatomix.com/postalCode/1.0#zip | 03833 |
| postal://zip#03060 | http://www.metatomix.com/postalCode/1.0#town | Nashua |
| postal://zip#03060 | http://www.metatomix.com/postalCode/1.0#state | NH |
| postal://zip#03060 | http://www.metatomix.com/postalCode/1.0#country | USA |
| postal://zip#03060 | http://www.metatomix.com/postalCode/1.0#zip | 03060 |
| postal://zip#03301 | http://www.metatomix.com/postalCode/1.0#town | Concord |
| postal://zip#03301 | http://www.metatomix.com/postalCode/1.0#state | NH |
| postal://zip#03301 | http://www.metatomix.com/postalCode/1.0#country | USA |
| postal://zip#03301 | http://www.metatomix.com/postalCode/1.0#zip | 03301 |
| postal://zip#05601 | http://www.metatomix.com/postalCode/1.0#town | Montpelier |
| postal://zip#05601 | http://www.metatomix.com/postalCode/1.0#state | VT |
| postal://zip#05601 | http://www.metatomix.com/postalCode/1.0#country | USA |
| postal://zip#05601 | http://www.metatomix.com/postalCode/1.0#zip | 05601 |
| postal://zip#05451 | http://www.metatomix.com/postalCode/1.0#town | Essex |
| postal://zip#05451 | http://www.metatomix.com/postalCode/1.0#state | VT |
| postal://zip#05451 | http://www.metatomix.com/postalCode/1.0#country | USA |
| postal://zip#05451 | http://www.metatomix.com/postalCode/1.0#zip | 05451 |
| postal://zip#05401 | http://www.metatomix.com/postalCode/1.0#town | Burlington |
| postal://zip#05401 | http://www.metatomix.com/postalCode/1.0#state | VT |
| postal://zip#05401 | http://www.metatomix.com/postalCode/1.0#country | USA |
| postal://zip#05401 | http://www.metatomix.com/postalCode/1.0#zip | 05401 |
| postal://zip#04401 | http://www.metatomix.com/postalCode/1.0#town | Bangor |
| postal://zip#04401 | http://www.metatomix.com/postalCode/1.0#state | ME |
| postal://zip#04401 | http://www.metatomix.com/postalCode/1.0#country | USA |
| postal://zip#04401 | http://www.metatomix.com/postalCode/1.0#zip | 04401 |
| postal://zip#03901 | http://www.metatomix.com/postalCode/1.0#town | Berwick |
| postal://zip#03901 | http://www.metatomix.com/postalCode/1.0#state | ME |
| postal://zip#03901 | http://www.metatomix.com/postalCode/1.0#country | USA |
| postal://zip#03901 | http://www.metatomix.com/postalCode/1.0#zip | 03901 |
| postal://zip#04330 | http://www.metatomix.com/postalCode/1.0#town | Augusta |
| postal://zip#04330 | http://www.metatomix.com/postalCode/1.0#state | ME |
| postal://zip#04330 | http://www.metatomix.com/postalCode/1.0#country | USA |
| postal://zip#04330 | http://www.metatomix.com/postalCode/1.0#zip | 04330 |
| postal://zip#72716 | http://www.metatomix.com/postalCode/1.0#town | Bentonville |
| postal://zip#72716 | http://www.metatomix.com/postalCode/1.0#state | AR |
| postal://zip#72716 | http://www.metatomix.com/postalCode/1.0#country | USA |
| postal://zip#72716 | http://www.metatomix.com/postalCode/1.0#zip | 72716 |
| postal://zip#75039 | http://www.metatomix.com/postalCode/1.0#town | Irving |
| postal://zip#75039 | http://www.metatomix.com/postalCode/1.0#state | TX |
| postal://zip#75039 | http://www.metatomix.com/postalCode/1.0#country | USA |
| postal://zip#75039 | http://www.metatomix.com/postalCode/1.0#zip | 75039 |
| postal://zip#48265 | http://www.metatomix.com/postalCode/1.0#town | Detroit |
| postal://zip#48265 | http://www.metatomix.com/postalCode/1.0#state | MI |
| postal://zip#48265 | http://www.metatomix.com/postalCode/1.0#country | USA |
| postal://zip#48265 | http://www.metatomix.com/postalCode/1.0#zip | 48265 |

As is evident, the text on FIG. 2B is, for all intents and purposes, illegible. The relationships among subjects, predicates and triplets are likewise nearly impossible to determine. This is increasingly so as the size and complexity of the data set increases.

FIGS. 3A-3C are graphs, hereinafter referred to as a “meta-directed” graphs, of the type generated by methods and apparatus according to the invention, for display on a computer monitor, printer, plotter or other output device. These are generated from the same data set (reprinted above) used to generate FIG. 2B. Unlike a conventional directed graph, a meta directed graph does not depict relationships among individual subjects and individual objects. Rather, it depicts relationships among groups of subjects and groups of objects, where
(i) The subjects are grouped according to commonality of their identifiers—in this case, according to common <scheme> and <path>. In other embodiments, 25 other common portions of the identifiers may be used in addition or instead.
(ii) The objects are grouped by the commonality of the identifiers of the predicates by which they are associated with the subjects in a subject group—in this case, according to common <scheme>, <path> and <fragment>. In other embodiments, other common portions of the identifiers may be used in addition or instead.

In some embodiments, grouping rules (i) and (ii) are applied as stated above. However, in the illustrated embodiment, grouping rule (i) is applied to resource-type objects and, con35 versely, grouping rule (ii) is applied to literal-type objects.

Referring to FIG. 3A, each group of subjects displayed, e.g., on computer monitor 300, is depicted by a node or other icon. As noted above, here, the subjects of the underlying 12 data set have been grouped so that those with a common <scheme> and <path> are represented as a node. Since all subjects in the graphed data set have the same <scheme>, i.e., “postal,” and <path>, i.e., “zip,” only a single subject group icon 302 is shown. In data sets with a greater variety subjects, more subject icons might be shown.

This is likewise true of embodiments where the degree of commonality among subjects in a group varies. For example, in an embodiment in which subjects are grouped according to a common <scheme>, <path> and first digit of <fragment>, FIG. 3A would have three group icons: one for subjects beginning with “postal://zip#0,” one for subjects beginning with “postal://zip#4” and one for subjects beginning with “postal://zip#7.”

The group icons, e.g., 302, can be labeled, for example, to indicate the common portion(s) of the identifiers from which they are formed—here, the common <scheme> and <path>. Of course, other labels can be used as well. And, of course, although an oval icon is used in the illustration, it will be appreciated that any other graphical and/or textual representation of the respective groups can be used in addition or instead.

With continued reference to FIG. 3A, the objects (of the literal type) associated with the subjects in each group (here, the single group represented by icon 302) are grouped by the commonality of the identifiers of the predicates by which they are associated with those subjects in the RDF data set. Here, the degree of commonality among predicate identifiers is <scheme> and <path> and <fragment>, resulting in:
A node 304 for the objects associated with the subjects in the group represented by node 302 via the predicate “http://www.metatomix.com/postalCode/1.0#state.”
A node 306 for the objects associated with the subjects in the group represented by node 302 via the predicate “http://www.metatomix.com/postalCode/1.0#country.”
A node 308 for the objects associated with the subjects in the group represented by node 302 via the predicate “http://www.metatomix.com/postalCode/1.0#zip.”
A node 310 for the objects associated with the subjects in the group represented by node 302 via the predicate “http://www.metatomix.com/postalCode/1.0#town.”

As above, in data sets with a greater variety of predicates, more object icons might be shown; in those with less variety, fewer might be shown. Paralleling the example given above, this is likewise true of embodiments where the degree of commonality among predicates in a group varies.

The object icons, e.g., 304-310, can be labeled, for example, to indicate the common portion(s) of the identifiers from which they are formed—here, the common <fragment>. Of course, other labels can be used as well. And, of course, although an oval icon is used in the illustration, it will be appreciated that any other graphical and/or textual representation of the respective groups can be used in addition or instead.

With still further reference to FIG. 3A, the fact that a given group of objects represented by an object icon, e.g., icon 304, is related to a given group of subjects represented by a subject icon, e.g., 302, by way of predicates whose identifiers have a common <scheme> and <path> and <fragment> is indicated by a directed arc “icon” 312. In alternative embodiments, icons of other shapes (graphical and/or textual) may be used to indicate such a relationship. Indeed, depending on complexity, no such icon may be used—e.g., as where placing the subject group icons in reasonable vicinity to the associated object group icons suffices to indicate a relationship exists.

FIG. 3B is a meta-directed graph generated, e.g., for display on computer monitor 300, by methods according to a further embodiment of the invention and/or by an alternate mode (user-selected or otherwise) of the embodiment discussed above in connection with FIG. 3A. Here, additional labeling is presented with the subject group, predicate and object group icons.

Specifically, rather than merely labelling the group icon 302 with the common <path> portion of the identifiers from which they are formed, the <scheme> is included as well. In addition, a count of the number of unique subjects in the group is provided. For the data set underlying FIGS. 3A and 3B (as well as that underlying FIG. 2B), there are 21 unique subjects among the triples with subjects having the common <scheme> and <path> of “postal://zip.” This is so indicated in parentheses in icon 302. Meta-directed graphs generated by methods and apparatus according to other embodiments of the invention may use other visual aids, in addition or instead, to indicate counts or to indicate the existence of multiple subjects in a group. One such visual aid is a display of stacked icons (in place of an individual icon) where the corresponding group has multiple members.

With respect to the predicate icons 312, i.e., directed arcs in the drawing, FIG. 3B provides adjacent text labels containing the corresponding predicate identifiers. Of course, partial identifiers (e.g., the <fragment> portions) can be presented in place of the full identifiers shown in the drawing.

With respect to the object icons 304-310, rather than merely using labeling with the common <fragment> portion of the predicate identifiers, a count of the number of unique objects in the group is provided. As indicated in FIG. 3B, for the data set underlying FIGS. 3A and 3B (as well as that underlying FIG. 2B), there are nine unique state identifiers among the objects in the group represented by icon 304; one unique country identifier in the group represented by icon 306; 21 unique zip identifiers in the group represented by icon 308; and 21 unique town identifiers in the group represented by icon 310. As noted above, other visual aids (such as stacked icons) may be used, in addition or instead, for object groups that have multiple members.

FIG. 3C is a meta-directed graph generated, e.g., for display on computer monitor 300, by methods according to a further embodiment of the invention and/or by an alternate mode (user-selected or otherwise) of the embodiment discussed above in connection with FIGS. 3A or 3B. Here, an enumeration of the unique identifiers of objects in the group represented by icon 304 are displayed, namely, the unique two-letter state abbreviations contained in the objects associated with the predicate http://www.metatomix.com/postalCode/1.0#state” for the subjects in the group represented by icon 302. This enumeration can be presented adjacent the group icon 304 to which it pertains, or elsewhere. Moreover, the enumeration may contain additional information, such as the indicated display directives (zoom in, zoom out, center element, original view) or other directives or information.

While the graphs of FIGS. 3A and 3B can be presented statically, e.g., on computer monitor 300 or otherwise, at least the enumerated portion of the meta-directed graph of FIG. 3C is typically presented by dynamically, e.g., in response to a user-directive, for example, right-clicking of a mouse while pointing at icon 304. Further, though FIG. 3C shows an enumeration of unique identifiers of objects in the group represented by icon 304, it will be appreciated enumerations of identifiers of objects in the other groups 306-310 and/or of the subjects in group 302 can also be presented, e.g., also in response to a user-directive or otherwise.

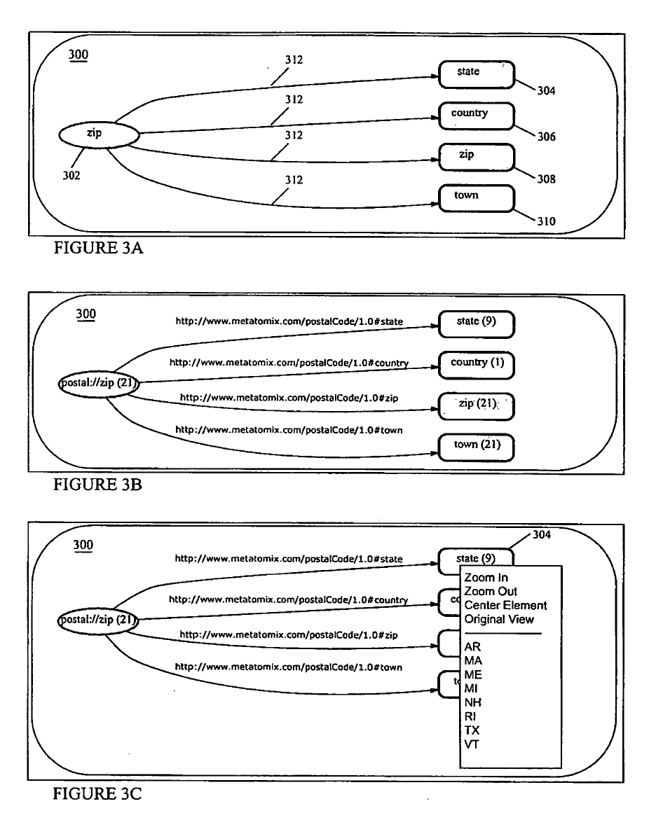

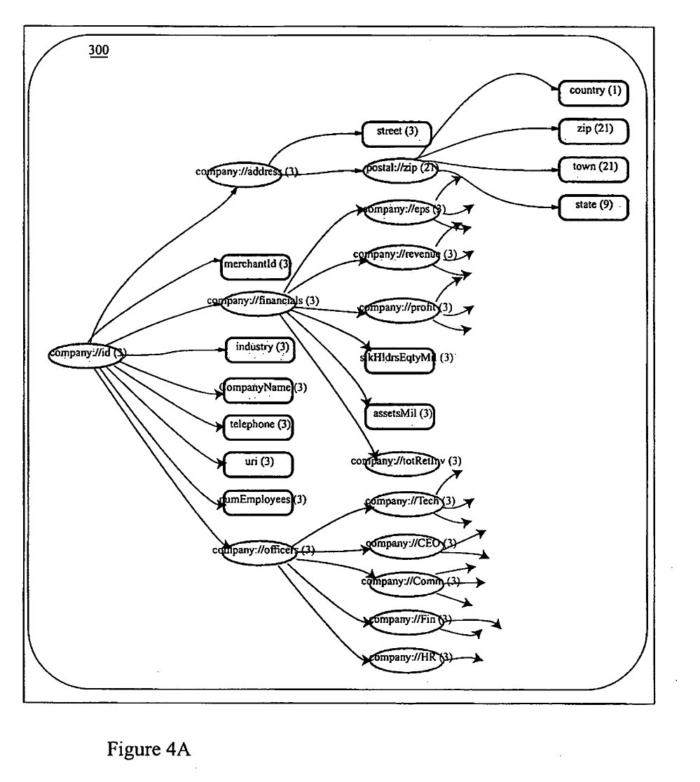

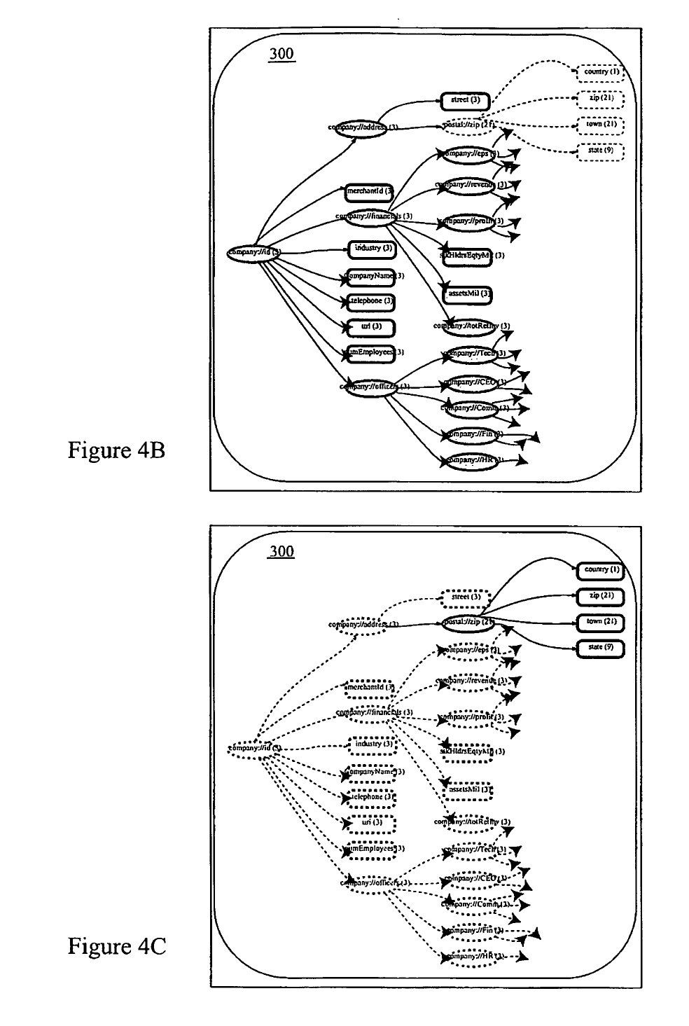

FIG. 4A is another interactive meta-directed graph generated, e.g., for display on computer monitor 300, by methods according to a further embodiment of the invention and/or by an alternate mode (user-selected or otherwise) of the embodiment discussed above in connection with FIGS. 3A or 3B. Here, selected icons corresponding to the subject and object groupings (and predicates) of multiple data sets are simultaneously presented: i) the zip code data set underlying FIGS. 3A and 3B, and (ii) a separate company information data set. The former data set is presented above, excerpts of the latter data set are presented below (in XML syntax):

<rdf:Description rdf:about=”company://id#0”>
<CompanyName>WAL MART STORES INC</CompanyName>
<merchantId>0</merchantId>
<financials rdf:resource=”company://financials#0”/>
<numEmployees>1,383,000</numEmployees>
<industry>General Merchandisers</industry>
<address rdf:resource=”company://address#0”/>
<telephone>(479) 273-4000</telephone>
<uri/>http://www.walmartstores.com/</uri>
<officers rdf:resource=”company://officers#0”/>
</rdf:Description>
<rdf:Description rdf:about=”company://address#0”>
<street>702 Southwest Eighth St.</street>
<postalCode rdf:resource=”postal://zip#72716”/>
</rdf:Description>
<rdf:Description rdf:about=”company://officers#0”>
<CEO rdf:resource=”company://CEO#0”/>
<Fin rdf:resource=”company://Fin#0”/>
<HR rdf:resource=”company://HR#0”/>
<Tech rdf:resource=”company://Tech#0”/>
<Comm rdf:resource=”company://Comm#0”/>
</rdf:Description>
<rdf:Description rdf:about=”company://financials#0”>
<revenue rdf:resource=”company://revenue#0”/>
<profit rdf:resource=”company://profit#0”/>
<assetsMil>83,375</assetsMil>
<stkHldrsEqtyMil>35,102</stkHldrsEqtyMil>
<eps rdf:resource=”company://eps#0”/>
<totRetInv rdf:resource=”company://totRetInv#0”/>
</rdf:Description>
<rdf:Description rdf:about=”company://id#1”>
<CompanyName>EXXON MOBIL CORP</CompanyName>
<merchantId>1</merchantId>
<financials rdf:resource=”company://financials#1”/>
<numEmployees>97,900</numEmployees>
<industry>Petroleum Refining</industry>
<address rdf:resource=”company://address#1”/>
<telephone>(972) 444-1000</telephone>
<ticker rdf:resource=”company://ticker#1”/>
<uri>http://www.exxonmobil.com/</uri>
<officers rdf:resource=”company://officers#1”/>
</rdf:Description>
<rdf:Description rdf:about=”company://address#1”>
<street>5959 Las Colinas Blvd.</street>
<postalCode rdf:resource=”postal://zip#75039”/>
</rdf:Description>
<rdf:Description rdf:about=”company://officers#1”>
<CEO rdf:resource=”company://CEO#1”/>
<Fin rdf:resource=”company://Fin#1”/>
<HR rdf:resource=”company://HR#1”/>
<Tech rdf:resource=”company://Tech#1”/>
<Comm rdf:resource=”company://Comm#1”/>
</rdf:Description>
<rdf:Description rdf:about=”company://financials#1”>
<revenue rdf:resource=”company://revenue#1”/>
<profit rdf:resource=”company://profit#1”/>
<assetsMil>143,174</assetsMil>
<stkHldrsEqtyMil>73,161</stkHldrsEqtyMil>
<eps rdf:resource=”company://eps#1”/>
<totRetInv rdf:resource=”company://totRetInv#1”/>
</rdf:Description>
<rdf:Description rdf:about=”company://id#2”>
<CompanyName>GENERAL MOTORS CORP</CompanyName>
<merchantId>2</merchantId>
<financials rdf:resource=”company://financials#2”/>
<numEmployees>365,000</numEmployees>
<industry>Motor Vehicles and Parts</industry>
<address rdf:resource=”company://address#2”/>
<telephone>(313) 556-5000</telephone>
<ticker rdf:resource=”company://ticker#2”/>
<uri>http://www.gm.com/</uri>
<officers rdf:resource=”company://officers#2”/>
</rdf:Description>
<rdf:Description rdf:about=”company://address#2”>
<street>300 Renaissance Center</street>
<postalCode rdf:resource=”postal://zip#48265”/>
</rdf:Description>
<rdf:Description rdf:about=”company://officers#2”>
<CEO rdf:resource=”company://CEO#2”/>
<Fin rdf:resource=”company://Fin#2”/>
<HR rdf:resource=”company://HR#2”/>
<Tech rdf:resource=”company://Tech#2”/>
<Comm rdf:resource=”company://Comm#2”/>
</rdf:Description>
<rdf:Description rdf:about=”company://financials#2”>
<revenue rdf:resource=”company://revenue#2”/>
<profit rdf:resource=”company://profit#2”/>
<assetsMil>323,969</assetsMil>
<stkHldrsEqtyMil>19,707</stkHldrsEqtyMil>
<eps rdf:resource=”company://eps#2”/>
<totRetInv rdf:resource=”company://totRetInv#2”/>
</rdf:Description>

The icons of FIG. 4A are displayed in the manner described above, e.g., with respect to FIGS. 3A-3B. It will be noted that, even though from two data sets, the icons appear as a single, consolidated graph on account of the RDF triples of the company information data set (excerpted immediately above) that declare, as objects, zip code-related resources defined in the zip code data set (reprinted earlier). It will also be noted that resource-type objects—that is, those labeled by <scheme> and <path> identifiers (e.g., “company://financials,” “company://officers,” “postal://zip,” and so forth)—are grouped in the same manner as subjects (i.e., by <scheme> and <path>, in the illustrated embodiment.

The icons shown in FIG. 4A attributable to each data set may be deactivated, e.g., by user-directives (e.g., selection of a menu item) or otherwise. This is indicated in FIGS. 4B and 4C, the former showing deactivation of the icons attributable to the zip code data set and the latter showing deactivation of the icons attributable to the company information data set. The labels within the icons of these figures are not intended for legibility and may be removed without detracting from the purposes thereof.

Though deactivation is intended to be shown here as a “graying out” of icons from the respective data sets, it will be appreciated that other visual aids could be used as well, such as removing the deactivated icons in entirety from the display, emphasizing highlighting on the activated icons, and so forth.

In the illustrated embodiment, deactivated icons cannot be selected, e.g., for purposes of enumeration of their constituent subjects or objects in the manner of FIG. 3C. Nor, as noted in the prior paragraph are they as visually apparent, as their activated counterparts. Nonetheless, depending upon implementation, the deactivated icons may be susceptible to movement on the display, updating, and/or other operations.

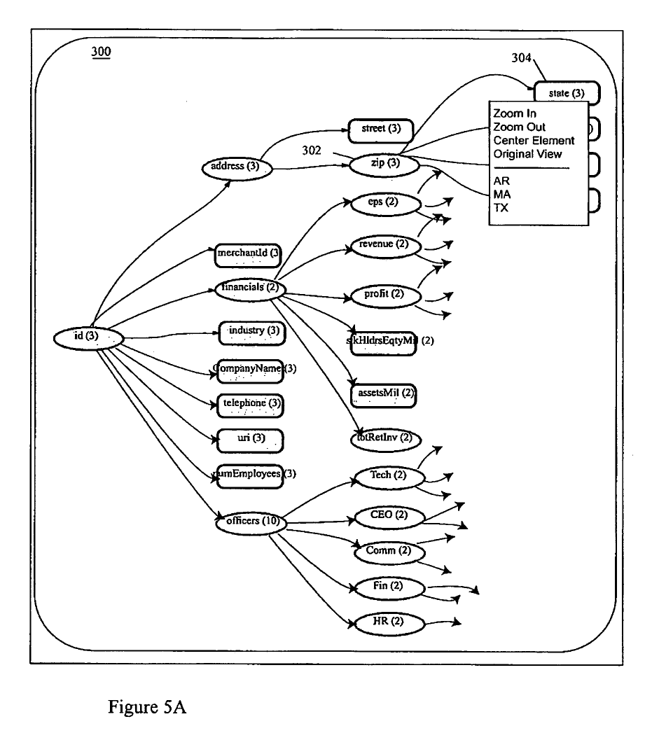

Referring to FIG. 5A, in the illustrated embodiment, a presentation of the type shown in FIG. 4A can include an enumeration of identifiers in the manner of FIG. 3C—again, for example, in response to user-directives. As with the prior drawing, FIG. 5A shows such an enumeration (here, of two-letter state identifiers) adjacent icon 304, representing objects associated with the predicate http://www.metatomix.com/postalCode/1.0#state” for the subjects in the group represented by icon 302. <Scheme> identifiers have been removed from labelling in FIG. 5A to facilitate understanding.

With reference, now, to FIG. 5B, in the illustrated embodiment, methods and apparatus according to the invention can effect updating of a presentation of the type shown in FIG. 5A, in response to user-directives or otherwise. Here, the display is updated to reflect selection of specific ones (here, “MA”) of the enumerated identifiers, e.g., via user right mouse-click or otherwise. The selections are highlighted in the conventional manner, e.g., reverse text, though other visual aids can be employed as well.

The display is also updated to reflect propagation of those selections throughout the meta-directed graph. Specifically, it is updated to reflect relationships among groups of subjects and objects directly or indirectly related to the objects (or subjects) selected in the enumeration—or, more exactly, the objects (or subjects) represented in the enumerated group (here, the objects represented by icon 304) having identifiers that match those selected in the enumeration.

Still more specifically, it is updated to reflect deactivation of those groups of subjects and objects neither directly nor indirectly related to the objects (or subjects) selected in the enumeration. In addition to deactivation of icons representing those non-related groups, any counts provided in the labelling of those icons (see, FIG. 3B) can also updated as if the triples represented by those icons were not in the data set to begin with.

The effect of the foregoing is evident upon comparison of FIGS. 5A and 5B. Selection of the enumerated state code “MA” (for Massachusetts) has the effect of deactivating icons for subject and object groups not directly related to the triple (or triples) to that which gave rise to the “MA” enumeration. It also has the effect of reducing counts in both the activated and deactivated icon labels. In the specific data sets represented, which reflects data of three companies from three different states, it is as if triples from the two non-Massachusetts were not present in the data sets to begin with—except, insofar as deactivated icons (which would not have been displayed in the first place) remain on the display 300, albeit in deactivated condition.

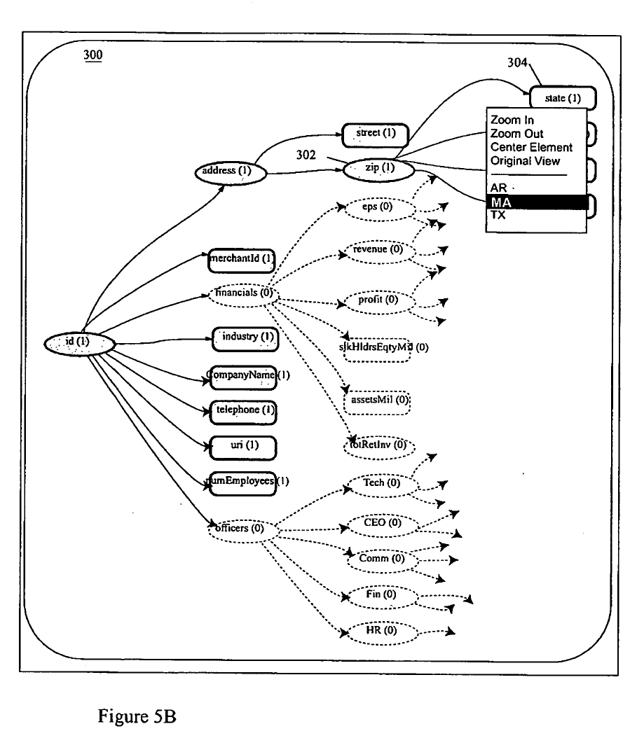

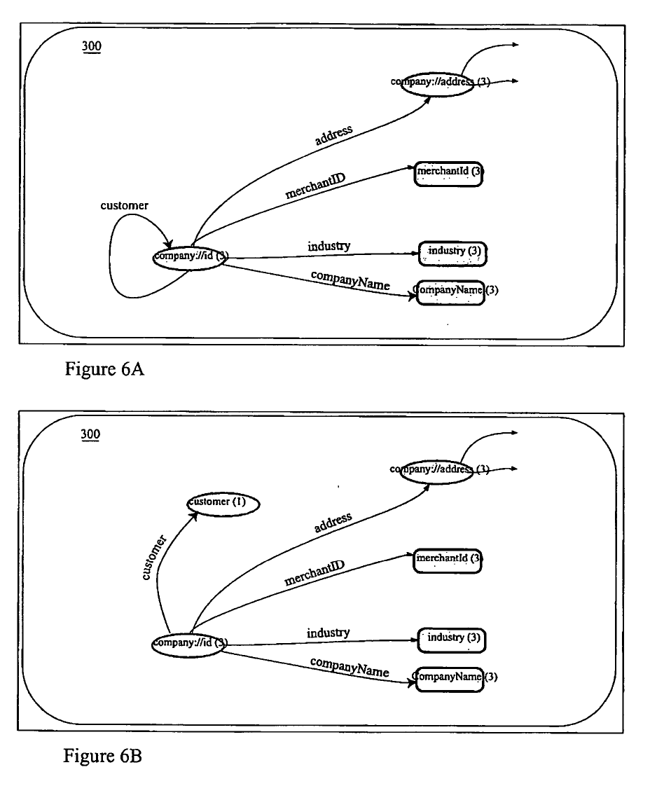

FIG. 6A is a meta-directed graph generated, e.g., for display on computer monitor 300, by methods according to a further embodiment of the invention and/or by an alternate mode (user-selected or otherwise) of the embodiments discussed above. Here, icons representing subject and object groupings (and predicates) corresponding to RDF triples of the aforementioned company information data set are presented. For simplicity, icons corresponding to groupings of several of the resource-type objects (and a few of the literal-type objects) are not shown.

Of note in present regards, however, there is shown a predicate icon, labelled “customer,” depicting a self-referencing relationship by a subject grouping. Particularly, that predicate icon represents one or more RDF triples that specify “company://id” subjects which have—by way of a customer (predicate) relationship—resource-type objects of the same type, to wit, “company://id.”

The nature of that relationship can be depicted in greater detail, according to these embodiments, in the manner shown in FIG. 6B. Particularly, by way of example, in response to a user-directive (e.g., right-clicking of the “customer” predicate icon) or otherwise, the self-referencing subject grouping icon “company://id” of FIG. 6A is expanded or “zoomed” to show an object grouping icon. In the illustration, that latter icon is presented and labelled as if it represented a group of literal-type objects in a customer (predicate) relationship with the original self-referencing subject grouping icon. In other embodiments, alternative labelling can be used, e.g., the resource identifier “company://id” label can be applied to the newly presented object grouping icon. In still other embodiments, other visual aids can be used, in addition or instead, to depict the more precise nature of self-referencing subject grouping icons, e.g., nodes other than the original self-referencing subject grouping icon and the newly presented object grouping icon can be visually de-emphasized to better convey that the displayed icons are a “zoomed” view of the overall data set.

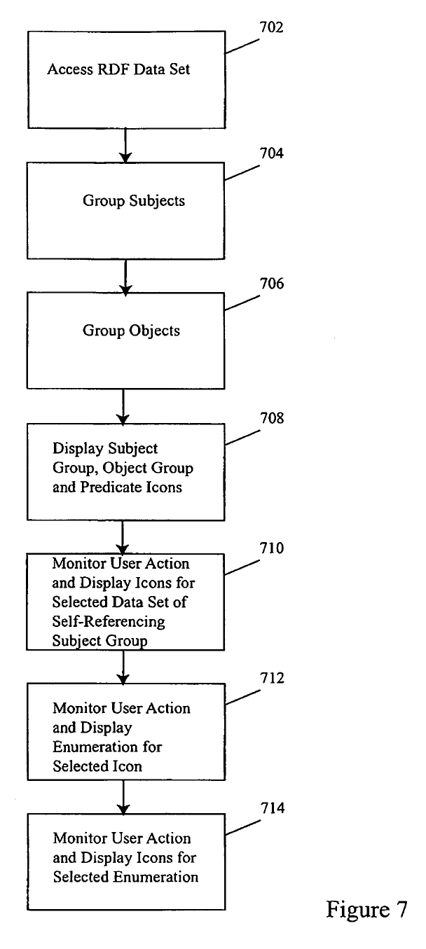

FIG. 7 is a flow chart of a methodology according to the invention for generating meta-directed graphs as shown in FIG. 3A-5B. The methods can be implemented on a PC, workstation or other general-purpose or specific-purpose digital data processor, e.g., with a display 300 and graphical user interface. In the illustrated embodiment, meta-directed graphs are generated using scalable vector graphics (SVG), which are highly portable; however, other graphics software can be used instead or in addition.

In step 702, the data set containing RDF triples to be presented is accessed. The data set can be a database, a memory-resident table or other data collection. As noted above, the data set can represent a consolidation of multiple databases or other data collections. The RDF triples can be in XML syntax or any other format suitable for expression thereof. Where the data set is not already RDF triple form, it can be converted thereto (e.g., from relational, hierarchical or other form) using conventional techniques known in the art.

In step 704, subjects within the accessed data set are grouped according to commonality of their respective identifiers. In the illustrated embodiment, groups are formed of triples whose subject identifiers have common <scheme> and <path> portions. Grouping can also be accomplished by using other common portions of the identifiers in addition or instead, for example, <scheme>, <path> and a portion of <fragment> or, if applicable, fragment alone—to name a few examples. Given commonality parameters in accord with the teachings hereof, the groupings can be formed by sorting, data collection or other techniques known in the art.

In step 706, literal-type objects from the triples contained in each respective subject group are (the objects) themselves grouped according to commonality of the identifiers of the predicates of the triples in their respective subject groups. In the illustrated embodiment, groups are formed of objects whose associated predicates have identifiers with common <scheme>, <path> and <fragment> portions. Resource-type objects, on the other hand, are grouped in the same manner discussed above, in connection with step 704. Of course, as with grouping the subjects, the objects (whether of the literal or resource types) can be grouped using other common portions of the respective identifiers. Again, given commonality parameters in accord with the teachings hereof, the groupings can be formed by sorting, data collection or other techniques known in the art.

In step 708, icons representing each of the subject groups, object groups and predicates are presented, e.g., on computer display 300, or otherwise. The icons are labeled, e.g., as indicated above in connection with FIGS. 3A-3B, or otherwise. Once icons have been determined in accord with the teachings hereof, they can be presented, e.g., on the computer display 300 or otherwise, in a conventional manner known in the art.

In step 710 of embodiments with the presentation capabilities indicated in FIGS. 4A-4C, user input is monitored to discern if a menu item is selected for activation or deactivation of icons corresponding to one of multiple presented data sets. If so, the corresponding icons are activated or deactivated on the display, e.g., in the manner discussed above in connection with those figures. In the illustrated embodiment, icons to be activated or deactivated are determined by re-execution of steps 704-706 with respect to the data sets selected. Other techniques, such as tagging displayed icons upon initial presentation in step 708 and updating the display based on data set selection, can be used instead or in addition.

In step 710 of embodiments with the presentation capabilities indicated in FIGS. 6A-6B, user input is monitored to discern if a user directive is issued for purposes of detailing the ₂₅ nature of a self-referencing object. If so, new object and predicate icons are generated as shown in FIG. 6B and discussed in detail above. Other icons on the display can be depicted as deactivated, or otherwise, to visually emphasize to the user that a zoom view is being presented. In addition to so modifying the display, embodiments of the invention can respond to the user directive by generating a query (e.g., for application the underlying RDF data set) to call out triples directly or indirectly related to those giving rise to the self-referencing object.

In step 712 of embodiments with the presentation capabilities indicated in FIG. 3C, user input is monitored to discern if an icon is selected for enumeration (e.g., via a right-click of a mouse or otherwise). If so, an enumeration of objects (or subjects) represented by the icon are displayed. This can be an enumeration of unique objects (or subjects), as indicated above, of all objects (or subjects), or of some other subset or superset. Once groupings have been determined and icons displayed in the manner discussed above, presentation of the objects (or subjects) in a group represented by a selected icon can be performed in the conventional manner known in the art, e.g., by list box control, or otherwise. Associations between icons and their underlying objects (or subjects) can be accomplished through use of tags, back-pointers or otherwise.

In step 714 of embodiments with the presentation capabilities indicated in FIGS. 5A-5B, user input is monitored to discern if one or more object (or subject) identifier enumerations are selected (e.g., via a right-click of a mouse or otherwise). If so, the display is updated in the manner discussed above in connection with those figures. In the illustrated embodiment, updating is performed by re-execution of steps 704-706 with respect to triples directly or indirectly related to those selected in the enumeration. Counts in icon labels are updated, e.g., as shown in FIGS. 5A-5B and icons whose counts go to zero (e.g., for failure to fall within a group that is directly or indirectly related to the selected objects (or subjects)) are deactivated. Other techniques, such as flagging mentioned above, can be used instead or in addition.

According to a preferred practice of the invention, along with updating the display in step 714, the method can (at user option or otherwise) generate a subset of the RDF data set which includes only those triples directly or indirectly related to the selected objects (or subjects). This can be accomplished through use of tags, back-pointers or otherwise that associate specific data set triples to the displayed icons. Alternatively, it can be accomplished through generation of queries based on the activated (or deactivated) icons, which queries can be applied against the RDF data set using conventional techniques to discern the corresponding subset.

Regardless of how generated, a subset (or query) as discussed in the preceding paragraphs can be used for targeted analysis or treatment of the implicated triples or the entities (e.g., persons, companies, cities, etc.) to which they pertain. By way of non-limiting example, such a subset (or query) could be used to generated mailings or other targeted marketing materials.

Described above are methods and apparatus meeting the desired objects. Those skilled in the art will, of course, appreciate that these are merely examples and that other embodiments, incorporating modifications to those described herein fall within the scope of the invention, of which we claim:

1. A method for visualizing relationships between triples, each of which comprises a subject and an associated subject, predicate and object, the method comprising:
A. grouping subjects of at least selected ones of the triples based on commonality of at least portions of identifiers of those subjects,
B. for at least a selected subject group determined in step (a), grouping at least selected objects of at least selected triples whose subjects are in that subject group based on commonality of at least portions of identifiers of predicates of those triples,
C. displaying an icon representing each of a subject group determined in step (a) and an object group determined in step (B).

2. A method of claim 1, wherein step (B) includes grouping objects that are literals based on commonality of at least portions of identifiers of predicates of the respective triples.

3. A method of claim 1, comprising grouping objects that are resources based on commonality of at least portions of identifiers of those resources.

4. A method of claim 1, comprising displaying an icon indicating a relationship between the selected group of subjects displayed in step (C) and a selected group of objects displayed in step (C).

5. A method of claim 4, wherein the relationship-indicating icon visually associates the icon displayed for the selected group of objects with the icon displayed for the selected group of subjects.

6. A method of claim 1, comprising displaying with at least one subject or object group-representative icon displayed in step (C) an indication of a count of subjects or objects, respectively, in the group represented by that icon.

7. A method of claim 1, comprising selectively displaying with at least one subject or object group-representative icon displayed in step (C) an enumeration of one or more subjects or objects, respectively, in the group represented by that icon.

8. A method of claim 1, comprising selectively activating or deactivating one or more icons displayed in step (C).

9. A method of claim 8, comprising selectively activating or deactivating an icon by altering display thereof.

10. A method of claim 8, comprising responding to a user to selectively activate or deactivate one or more icons displayed in step (C).

11. A method of claim 1, comprising
selectively displaying with at least one subject or object group-representative icon displayed in step (C) an enumeration of one or more subjects or objects, respectively, in the group represented by that icon,
responding to selection of any of a subject or object displayed in an enumeration by updating the display of icons.

12. A method of claim 11, wherein the step of updating the display includes any of activating or deactivating icons related to a triple having an identifier corresponding to the subject or object selected in the enumeration.

13. A method of claim 11, wherein the step of updating includes updating a count of subjects or objects displayed with an icon representing a subject or object group, respectively.

14. A method for visualizing relationships between triples, each of which comprises a subject and an associated subject, object and predicate, the method comprising:
A. grouping subjects of at least selected ones of the triples based on commonality of at a least portion of identifiers of those subjects,
B. for at least a selected subject group determined in step (A), grouping objects of at least selected triples whose subjects are in that subject group based on commonality of at least a portion of identifiers of predicates of those triples,
C. displaying an icon representing each of a subject group determined in step (A) and an object group determined in step (B),
D. displaying an icon indicating a relationship between the selected group of subjects displayed in step (C) and a selected group of objects displayed in step (C), such that icons are displayed in a manner of a directed graph,
E. selectively displaying with at least one subject or object group-representative icon displayed in step (C) an enumeration of one or more subjects or objects, respectively, in the group represented by that icon,
F. selectively activating or deactivating one or more icons displayed in step (C).

15. A method of claim 14, wherein step (B) includes grouping objects that are literals based on commonality of at least portions of identifiers of predicates of the respective triples.

16. A method of claim 14, comprising grouping objects that are resources based on commonality of at least portions of identifiers of those resources.

17. A method of claim 14, wherein the triples comprises resource description framework triples.

18. A method of claim 17, wherein the triples are represented in an XML syntax.

19. A method of claim 14, wherein the triples represent multiple data sets.

20. A method of claim 19, comprising selectively activating or deactivating icons representing triples in a data set.

21. A method of claim 14, comprising generating any of a subset of triples and a query on a basis of a user selection with respect to the displayed icons.

22. A method of claim 21, comprising generating any of the subset and the query on a basis of a user selection of any of a subject an object in an enumeration displayed in step (D).

23. A method of claim 14, wherein step (A) includes grouping subjects based on commonality of <scheme> and <path> portions of their respective identifiers.

24. A method of claim 14, wherein step (B) includes grouping objects that are literals based on commonality of <scheme>, <path> and <fragment> portions of the identifiers of predicates of the respective triples.

25. A method of claim 14, comprising grouping objects that are resources based on commonality of <scheme> and <path> portions of their respective resource identifiers.
